(19) United States
(12) Patent Application Publication
(10) Pub. No.: US 2019/0387346 A1
(43) Pub. Date: Dec. 19, 2019

(54) Single Speaker Virtualization

(71) Applicant: Dolby Laboratories Licensing Corporation, San Francisco, CA (US)

(72) Inventors: Mark David DE BURGH, Mount Colah (AU); Timothy Alan PORT, Drummoyne (AU); David Matthew COOPER, Carlton (AU)

(73) Assignee: Dolby Laboratories Licensing Corporation, San Francisco, CA (US)

(21) Appl. No.: 16/440,540

(22) Filed: Jun. 13, 2019

Related U.S. Application Data
(60) Provisional application No. 62/838,067, filed on Apr. 24, 2019.
(60) Provisional application No. 62/684,318, filed on Jun. 13, 2018.

(51) Int. Cl. H04S 7/00; H04S 3/00; H04R 3/04

(52) U.S. Cl. CPC H04S 7/303; H04S 3/008; H04R 3/04; H04S 2400/15; H04S 2400/03; H04S 2400/11; H04S 2420/01

(57) ABSTRACT

Systems, methods, and computer program products of preparing an audio signal for playback on a monaural playback device A system receives an audio signal including one or more components, the one or more components including sound from one or more audio sources. The system processes the audio signal to create a monaural signal. The processing includes introducing one or more monaural cues into at least one component of the one or more components. The monaural signal maintains a presence of the one or more monaural cues. The system then provides the monaural signal to the monaural playback device or to a storage device. The one or more monaural cues are such that, if the monaural signal is played back to a listener using the monaural playback device, the listener experiences a perceived differentiation in direction of the one or more components and/or the one or more audio sources.

### CROSS-REFERENCE TO RELATED APPLICATION(S)

The present application claims priority to U.S. Provisional Patent Application No. 62/838,067 filed Apr. 24, 2019, and U.S. Provisional Patent Application No. 62/684,318 filed Jun. 13, 2018, both of which are incorporated herein by reference in its entirety.

### TECHNICAL FIELD

The present disclosure generally relates to audio signal processing. More in particular, the present disclosure relates to audio signal preparation for playback on a monaural playback device.

### BACKGROUND

In sound systems having two or more speakers, techniques such as binauralization and crosstalk cancellation may be used to virtually position a sound source (or sound component) such that its perceived location of origin is different from the individual locations of the speakers. By introducing auditory cues in form of time- and level-differences between the ears, and other spectral cues, a sound source may be virtually positioned anywhere within for example a horizontal plane of a listener, and at the same time also above or below the listener. By creating a more enveloping sound, the listening experience may be enhanced, and also provide e.g. an increased dialog clarity due to a reduced cluttering of the sound stage. One example is Dolby Virtual Surround.

### SUMMARY

According to a first aspect of the present disclosure, a method of preparing an audio signal for playback on a monaural playback device (such as a single speaker element) is provided. The method may include receiving an audio signal including one or more components. The one or more components may include sound from one or more audio sources. The method may include processing the audio signal to create a monaural signal. The processing may include introducing one or more monaural cues into at least one component, and/or into at least one combination of components, of the one or more components. The processing may be such that the monaural signal maintains a presence of the one or more monaural cues. The method may include providing the monaural signal to the monaural playback device or to a storage device (for later playback on a monaural playback device). In the method, the one or more monaural cues may be such that, if the monaural signal is played back to a listener using the monaural playback device, the listener experiences a perceived differentiation in direction of the one or more components and/or the one or more audio sources.

According to a second aspect of the present disclosure, an audio preparation system is provided. The audio preparation system may include a computer processor, and a non-transitory computer readable medium storing instructions which are operable, when executed by the processor, to cause the processor to perform the method as described with reference to the first aspect.

According to a third aspect of the present disclosure, a non-transitory computer readable medium provided. The non-transitory computer readable medium stores instructions which are operable, when executed by a computer processor, to perform the method as described with reference to the first aspect. The non-transitory computer readable medium of the third aspect may for example be the medium referred to above with reference to the second aspect, and vice versa.

Due to their limited sizes and/or cost constraints, many mobile devices such as for example mobile phones and portable speakers have only monaural playback over a single driver, with multiple drivers fed via a cross-over, and/or identically fed multiple speakers (to e.g. improve power handling). As a result, a multi-component audio signal originally intended to be played back using a multi-speaker system is often downmixed into a monaural signal before being fed to the one or more speakers of the devices. With a single speaker only, or e.g. with multiple speakers which are identically fed with a same signal or which receive different frequency ranges of a same monaural signal, binaural cues based on interaural time difference (ITD) and interaural level difference (ILD) may no longer be possible to reproduce, and the downmixing into the monaural signal may result in all sound components, no matter what their intended direction, being perceived as coming directly from the single speaker itself. This in turn may create a cluttered sound stage, and the listening experience for the user of the device may be negatively affected and different from that which was intended by e.g. the producer of the original multi-component audio signal.

The present disclosure improves upon existing technology by allowing the various sound/audio sources/components to appear as if originating from different elevations. This is achieved by performing appropriate processing of one or more of the components, and/or of one or more combinations of components, to introduce various monaural cues before dowmixing (if necessary) into a monaural signal. A processing as used herein may for example include applying one or more filters. As used herein, a filter may for example be a filter with a frequency response curve which, when applied to a component, makes the component appear as if its location of origin is e.g. above, below, behind or in front of the listener. By maintaining the presence of such monaural cues in the monaural signal, the sounds from the monaural playback device may thus, without relying on binaural cues and/or left to right differentiation, be made to appear to come from different locations in e.g. a median plane of the listener. For example, a sound of a helicopter may be made to appear as if coming from above, a sound of footsteps from below, and/or e.g. a sound of a door slam from behind. This may improve e.g. the envelopment and clarity of the listening experience, despite no available left to right differentiation. Instead, or in addition to, applying one or more filters to one or more components, it is envisaged also that a same or similar result may be obtained using other processing methods. For example, a transposer may be used to copy a spectral range of frequencies, apply scaling in frequency and/or in amplitude, and mix the result into another target range of frequencies. The target range of frequencies may then include the one or more monaural cues. Another processing method may for example include passing the audio signal, or at least one or more components of the audio signal, through a nonlinearity and then filter the result and optionally mixing it back into the original signal. This may for example provide an advantage for e.g. signals which have been bandlimited by compression for broadcast, for early recording limitations and/or e.g. for signals inherently lacking energy in a key frequency range containing the one or more monaural cues. It is envisaged e.g. that the one or more monaural cues may be added by interference in such a mixing process and not strictly by a filtering process.

As used herein, it is envisaged also that “processing” may include upmixing in order to create more components which were not present in the audio signal as originally received. As used herein, if such upmixing is performed, the “received audio signal” is considered to contain also these additional components created by upmixing. In addition, “upmixing” does not necessarily require the end-result to contain more components than what was originally available. It is envisaged that for example “upmixing” may include also replacing e.g. a component with another component obtained from e.g. a combination of components, and similar, as will be described in more detail later herein.

The present disclosure improves upon existing technology by using monaural cues to introduce a perceived differentiation in direction (within e.g. the median plane of the listener) also for sounds played back using only a single speaker. Other objects and advantages of the present disclosure will be apparent from the following description, the drawings, and the claims. Within the scope of the present disclosure, it is envisaged that all features and advantages described with reference to e.g. the method of the first aspect and/or the method of the second aspect are relevant for, and may be used in combination with, also the system of the third aspect and the medium of the fourth aspect, and vice versa.

### BRIEF DESCRIPTION OF THE DRAWINGS

Exemplifying embodiments will be described below with reference to the accompanying drawings, in which:

FIGS. 1a, 1b, and 1c illustrate schematically flowcharts of various embodiments of a method according to the present disclosure;

FIGS. 2a, 2b and 2c illustrate schematically virtual localization using a single speaker in various embodiments of a method according to the present disclosure;

FIGS. 3a, 3b, 3c and 3d illustrate schematically examples of various virtual filters usable to achieve virtual localization using a single speaker in various embodiments of a method according to the present disclosure;

FIGS. 4a to 4h illustrate schematically flowcharts of various embodiments of a method according to the present disclosure, and

FIG. 5 illustrates schematically an embodiment of an audio preparation system according to the present disclosure.

In the drawings, like reference numerals will be used for like elements unless stated otherwise. In general, the four first digits of a reference numeral are allocated such that the first digit is the same for all features shown in a same series of figures (such as in Figures “Xa”, “Xb”, . . . , etc.). The second digit is allocated such that it is different for each embodiment. The third and fourth digits are similar for similar features among the various embodiments. If needed, a dash followed by a fifth digit is introduced to distinguish between features which are similar but applies to different components, such as e.g. different components themselves or filters applied to different components. Unless explicitly stated to the contrary, the drawings show only such elements that are necessary to illustrate the example embodiments, while other elements, in the interest of clarity, may be omitted or merely suggested. As illustrated in the figures, the sizes of elements and regions may be exaggerated for illustrative purposes and, thus, are provided to illustrate the general structures of the embodiments.

### DETAILED DESCRIPTION

Exemplifying embodiments of a method, an audio preparation system and a non-transitory computer readable medium according to the present disclosure will now be described more fully hereinafter with reference to the accompanying drawings. The drawings show currently preferred embodiments, but the invention may, however, be embodied in many different forms and should not be construed as limited to the embodiments set forth herein; rather, these embodiments are provided for thoroughness and completeness, and fully convey the scope of the present disclosure to the skilled person.

Herein, various examples of how to prepare an audio signal for playback on a monaural playback device will be given. In many of the provided examples, one or more filters are used to process one or more components of the audio signal in order to introduce one or more monaural cues into the audio signal. It is, however, to be noted that it is envisaged also that such processing in order to introduce the one or more monaural cues may be performed by other means than strict filtering of one or more components, and/or one or more combinations of components, of the audio signal. As described earlier herein, this may be achieved using e.g. a transposer, and/or by using a nonlinearity and then filtering the result in some way, with optional mixing, in order to introduce the one or more monaural cues. Below, as many of the examples use one or more filters as a way of processing, a “processed signal” or e.g. “processed component” is referred to as a “filtered signal” or “filtered component”. Likewise, where the examples refers to e.g. a “filtering stage”, it is to be understood that a more general “processing stage” is also envisaged if other means than strict filtering are used, and that such a “processing stage” may also include e.g. upmixing, preprocessing and/or downmixing stages. Phrased differently, “filtering” is to be understood as one way of implementing a “processing”, or at least part of a “processing”, as envisaged in the present disclosure.

A sound of an “audio source” or “sound source” is envisaged as being a sound of e.g. a human, a vehicle, an animal or any other object which may produce a sound recordable by e.g. a microphone or set of microphones, or generated using e.g. computer software or similar. Sound from a same audio source may be present in more than one component. For example, a same audio source may have been recorded using microphones positioned at different positions and/or with different orientations, and it is envisaged that e.g. a sound captured by one microphone is included in one component and that a sound captured by another microphone is included in another component. In other embodiments, a sound of a particular audio source (or sounds of a particular group of audio sources) may be present in only one component. For example, an audio source may be a participant in a voice/video conference, and each component received may contain e.g. the voice of a single participant, or for example voices of a single group of participants. Within the present disclosure, it is envisaged to provide a perceived differentiation in direction between one or more components and/or between one or more audio sources. For example, a first component C₁ may include sound of two audio sources A₁ and A₂, while a second component C₂ may include sound of two audio sources A₃ and A₄. In some embodiments, it is envisaged that a perceived differentiation between components C₁ and C₂ includes A₁ and A₂ being perceived as being located at a first location (or e.g. coming from a first direction), and A₃ and A₄ being perceived as being located at a second location (or e.g. coming from a second direction) different from the first location/direction. In some embodiments, the perceived differentiation may instead mean that e.g. A₁ is being perceived as coming from a location different than a perceived location of A₂, and so on. In the first example, it may be said that the perceived differentiation is between the components themselves, while in the second example the perceived differentiation is between the audio sources themselves. In further embodiments, there may be e.g. only a single component C₁ including sound of a single audio source/object A₁. A perceived differentiation may then be a perceived differentiation over time, e.g. such that a perceived location of/direction to A₁ changes with time. Likewise, some embodiments may include there being a single component C₁ but which represents sound of two audio sources/objects A₁ and A₂, and the perceived differentiation may then be between the perceived locations of/directions to A₁ and A₂, etc. In still further embodiments, there may be a single component with a single audio souce A₁, and the perceived differentiation in direction may include creating multiple “copies” of A₁ and then distributing the virtual locations of these “copies” such that it appears to the listener as if there are multiple A₁'s located at different locations or at different directions. Other possibilities of creating a perceived differentiation between components and/or audio sources are of course also envisaged.

Even with only a single audio source, such a source may for example have reverberation (resulting from reflections off walls), or may be provided with such reverberation (or a simulation thereof) during processing. The reflections may for example be considered as additional audio sources, and differentiating these additional sources in direction would be considered a differentiation in direction of the single audio source. As another example, an audio source may have a sound which varies in frequency over time. As the frequency gets higher, it may e.g. be desirable to virtually locate the source at a higher (or lower) elevation, thereby creating a differentiation of e.g. a direction of the single audio source over time.

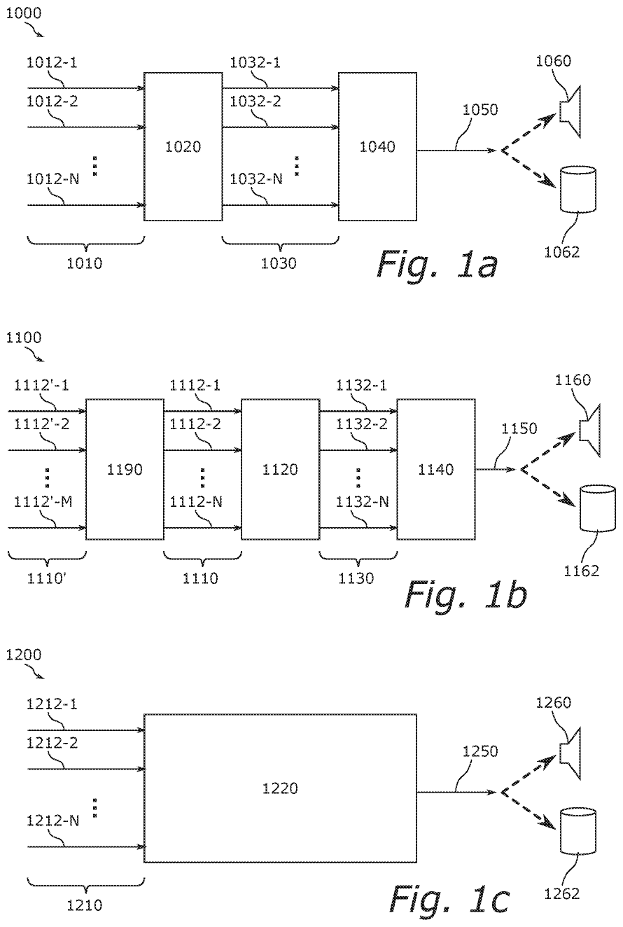

With reference to FIGS. 1a, 1 b, and 1c, various embodiments of a method of preparing an audio signal for playback on a monaural playback device will now be described in more detail.

FIG. 1a illustrates schematically a flowchart of a method 1000 according to one embodiment of the present disclosure. A received audio signal 1010 includes one or more components 1012-1 to 1012-N (where N is an integer such that N≥1). The one or more components 1012-1 to 1012-N are provided to a filtering stage 1020, wherein at least one filter is applied to at least one of the one or more components 1012-1 to 1012-N, in order to create a filtered (or processed) audio signal 1030 including one or more components 1032-1 to 1032-N. The at least one filter has a frequency response curve which introduces a presence of one or more monaural cues in the components to which the at least one filter is applied. It is noted that not necessarily all of the components 1012-1 to 1012-N receives a filtering treatment, and that some of the “filtered” components 1032-1 to 1032-N may therefore be identical to their respective “unfiltered” components 1012-1 to 1012-N. The at least one filter may for example be a “virtual height filter” or a “virtual depth filter” such as will be described in more detail later herein.

After the filtering stage 1020, the filtered (or processed) audio signal 1030 is provided to a mixing stage 1040. In the mixing stage 1040, the filtered audio signal 1030 is (down)mixed into a monaural signal 1050. The mixing performed in the mixing stage 1040 is such that the presence of the one or more monaural cues introduced by the filtering stage 1020 is still completely, or at least partially, maintained in the monaural signal 1050.

After being output from the mixing stage 1040, the monaural signal 1050 is provided to one or both of a monaural playback device 1060 (for immediate playback to a listener) and a storage device 1062 (such as e.g. a computer memory or audio tape, for later playback to a listener using a monaural playback device such as e.g. the monaural playback device 1060).

As will also be described in more detail later herein, the one or more monaural cues introduced by the filtering stage 1020 are such that, if the monaural signal 1050 is played back to the listener using the monaural playback device 1060, the listener will experience a perceived differentiation in direction of the one or more components 1012-1 to 1012-N included in the received audio signal 1010.

FIG. 1b illustrates schematically a flowchart of a method 1100 according to another embodiment of the present disclosure. The method 1100 differs from the method 1000 described with reference to FIG. 1a in that a preprocessing stage 1190 is provided. The preprocessing stage 1190 receives an audio signal 1110′ including one or more components 1112′-1 to 1112′-M (where M is an integer such that M≥1), and outputs an audio signal 1110 including the one or more components 1112-1 to 1112-N. For example, the preprocessing stage 1190 may be an upmixing stage, such that M<N. In other embodiments, the preprocessing stage 1190 may be a downmixing stage, such that M>N. In still other embodiments, the preprocessing stage 1190 may not necessarily change the number of components (i.e. M=N), but still perform one or more operations on the components 1112′-1 to 1112′-M such that some or all of the components 1112-1 to 1112-N are different from the components 1112′-1 to 1112′-M. Phrased differently, the components 1112-1 to 1112-N provided to the filtering stage 1120 may not necessarily be directly contained in the first audio signal received by the method (in the present example the audio signal 1110′), but instead be provided based on the first received audio signal 1110′ as part of the method 1100 itself. Herein, if not stated to the contrary, it may be assumed that the “received audio signal”, when used to describe any embodiment of a method according to the present disclosure, is a signal such as the audio signal 1110 including the components 1112-1 to 1112-N. It may also be envisaged that the preprocessing stage 1190, which may be an upmixing stage, generates the components 1112-1 to 1112-N by combining two or more of the components 1112′-1 to 1112′-N, either in a linear or non-linear fashion. It may then be envisaged that the received audio signal is the audio signal 1110′, and that the components 1112-1 to 1112-N are created as part of a processing to generate the monaural signal 1150. The components 1112-1 to 1112-N, may receive a filtering treatment to create a filtered (or processed) audio signal 1130 including one or more components 1132-1 to 1132-N as part of the processing.

After being output from the mixing stage 1140, the monaural signal 1150 is provided to one or both of a monaural playback device 1160 (for immediate playback to a listener) and a storage device 1162 (such as e.g. a computer memory or audio tape, for later playback to a listener using a monaural playback device such as e.g. the monaural playback device 1160).

FIG. 1c illustrates schematically a flowchart of a method 1200 according to one embodiment of the present disclosure. The method 1200 is more general than e.g. the methods 1000 and 1100 described with reference to FIGS. 1a and 1b, respectively, in that it contains only a more general processing stage 1220. The processing stage 1220 receives an audio signal 1210 including one or more components 1212-1 to 1212-N, processes at least one component, and/or at least one combination of components, of the components 1212-1 to 1212-N of the audio signal 1210 and outputs a monaural signal 1250. The monaural signal 1250 is then, as described above, provided to one or both of a monaural playback device 1260 and a storage device 1262.

In the method 1200, it is envisaged that the processing stage 1220 may include e.g. a filtering stage (such as the filtering stage 1020 or 1120), a preprocessing stage (such as the preprocessing stage 1190), a downmixing stage (such as the mixing stage 1040 or 1140), and/or other stages which may be used to provide the monaural signal 1250 based on the input audio signal 1210 and the one or more components 1212-1 to 1212-N. More generally, it may be envisaged that the audio signal 1210 may be represented as a column vector \vec{I} of size N×1, including one element Iₜ for each component 1212-1 to 1212-N. The operation of the processing stage 1220 on the audio signal 1210 may be represented as a matrix \hat{P} of size 1×N, such that the output signal O is given as O=\hat{P}\vec{I}. The processing may for example be a combination of a downmixing matrix \hat{D} of size 1×L, a filtering matrix \hat{F} of size L×K, and e.g. an upmixing and/or preprocessing matrix Û of size K×N, where L, K and N are integers and not necessarily equal, and such that \hat{P}=\hat{D}\hat{F}Û. It is noted that \hat{D}, \hat{f} and Û may be time varying and may have been derived via a non-linear analysis of \vec{I}. If no preprocessing and/or upmixing is used, it is envisaged that the matrix Û for example is unitary and have size N×N. Here, having a size “A×B” means having A rows and B columns. It is further envisaged that filtering (or processing in general) may operate not only on an instance of the input signal defined at a certain moment in time. A filter may for example take into account the value of the input signal also at earlier (and also, if available, future) times, and it is envisaged then that e.g. the vector Î may include multiple elements for each component, where each such element represents the value of the input audio signal component at a certain time. Phrased differently, a filter may or may not have a “memory”, where the output signal depends not only at a current value of one or more components but also at earlier and/or future values of the one or more components.

The “processing stage” may not necessarily explicitly create an upmixed version of a signal, apply one or more filters to one or more of the upmixed components, and then downmix the filtered versions of the upmixed components to create the monaural signal. Instead, it may be envisaged that the filter is designed such that only a filtering of one or more of the components in the received audio signal is performed before downmix, but such that the monaural signal so obtained is equal or at least approximately equal to the monaural signal obtained using the upmix+filter+downmix combination. For example, it may be envisaged that the processing stage first upmixes the received audio signal Î to create an upmixed signal Î_{UM}=Û\vec{I}, and that the processing stage then applies filtering to the upmixed signal to obtain a filtered signal \vec{I}_{F}=\hat{F}Î_{UM} before downmixing the filtered signal to obtain the monaural signal O =\hat{D}Î_{F}. As an alternative, as described above, it is also envisaged that the filtering (or processing in general) is instead such that the same result is obtained directly as O=\hat{F}′\vec{I}, where \hat{F}′ is a modified filter emulating or equaling the combined operation of \hat{D}\hat{F}Û. Such an embodiment may for example be useful if both of e.g. Û and \hat{F} are constant in time, as \hat{F}′ may be calculated once only and thereby reducing a number of required matrix operations when implementing the processing stage in e.g. a processor.

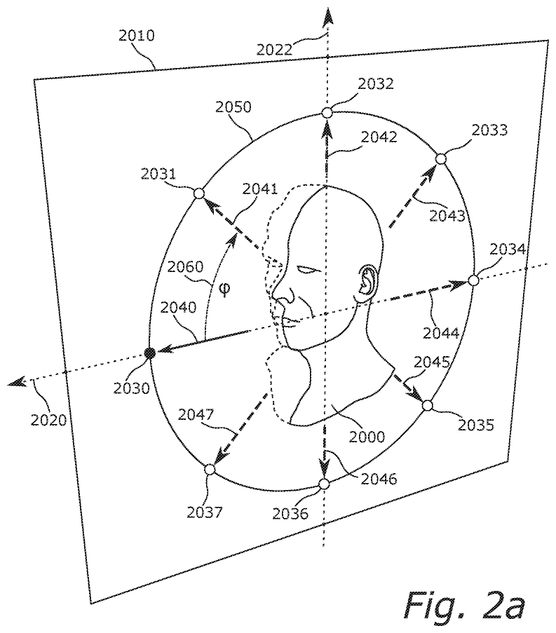

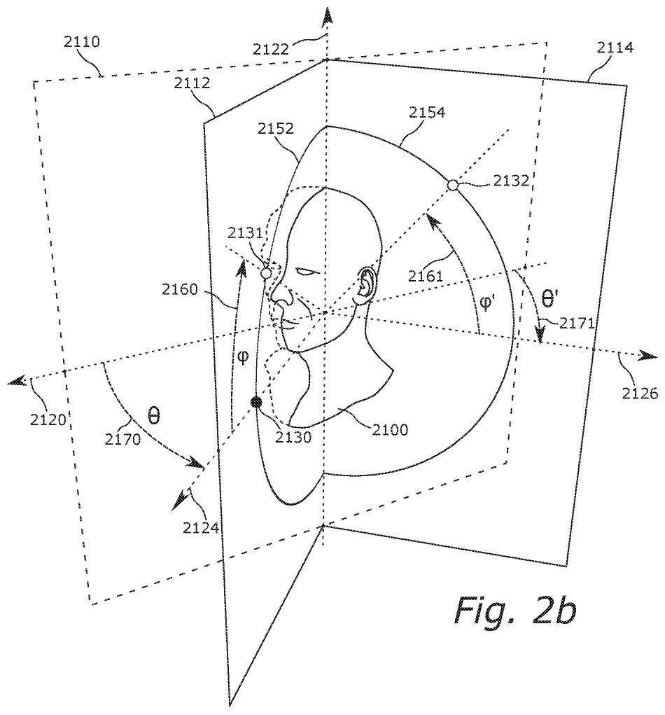

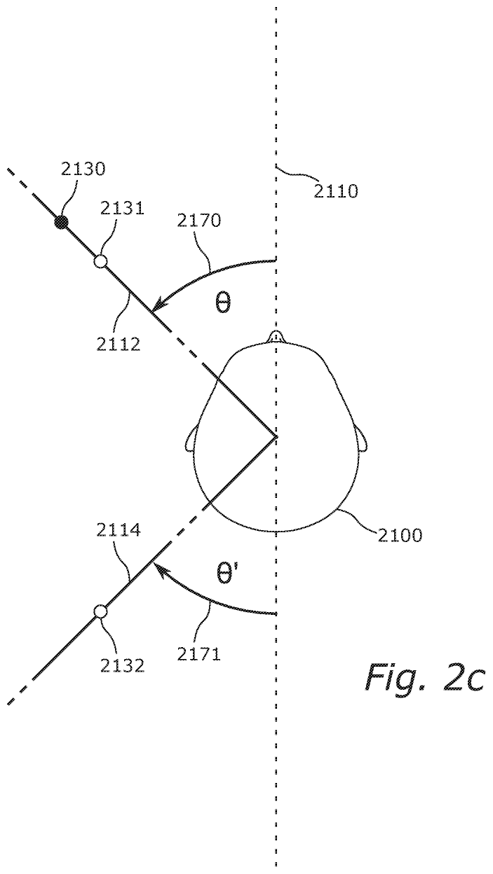

With reference to FIGS. 2a, 2b and 2c, the concept of virtual localization as provided by embodiments of the method according to the present disclosure will now be described in more detail.

FIG. 2a illustrates schematically a perspective view of head of a listener 2000, wherein the head of the listener 2000 is bisected vertically by a median (or mid-sagittal) plane 2010. The median plane 2010 has a depth (e.g. a forward/backward direction 2020), a height (e.g. an upward/downward direction 2022) but no width (i.e. no left/right direction). It is envisaged that the median plane 2010 is fixed to the orientation of the head of the listener 2000, such that if the head of the listener 2000 is rotated around some axis (e.g. the axis of upward/downward direction 2022), the median plane 2010 is rotated accordingly. Although illustrated in FIG. 2a as having a finite extension, it is envisaged that the median plane 2010 may extend infinitely in both the forward/backward direction 2020 and upward/downward direction 2022, respectively.

In the example provided in FIG. 2a, it is envisaged that a single speaker is positioned at the location 2030 (illustrated by the filled circle) directly in front of the head of the listener 2000. If the speaker plays back a sound including a sound component, the “location” of the component is said to be the location 2030. Likewise, the “direction” of the component is the direction 2040 from the head of the listener 2000 to the location 2030. Using other words, the “location” of a component is to be understood as the location from which it appears to the listener 2000 that the component is originating.

Using one or more filters of the type that will be described later herein, the method of the present disclosure provides a way of introducing a perceived differentiation in direction of two or more of the components. The location of the speaker will remain the same, but the perceived location and direction of one or more components will change. This will be referred to as “virtual localization” of the one or more components. As one example, a filter may virtually localize/locate a component such that it no longer appears to be located (or originating from) the location 2030, but instead appears to be coming from an elevated location (having a finite elevation angle 2060, p) such as the virtual location 2031 (illustrated by the empty circle). Using other words, this may be referred to as the component being virtually localized in front of and above the listener 2000 at e.g. the virtual location 2031. The elevation angle 2060 may for example be between 0° and 90°. The corresponding direction of the virtually localized component will then be the direction 2041 from the head of the listener 2000 to the virtual location 2031.

A virtual localization of a component will thus create a perceived differentiation in direction of the component being affected and one or more other components to which no such processing/filtering is applied.

The characteristics of the one or more filters may of course be changed, such that a component is instead virtually localized at other locations (also illustrated by empty circles) than the virtual location 2031 illustrated in FIG. 2a. For example, the component may be virtually localized above the listener 2000 (e.g. at the virtual location 2032, with direction 2042 and at an elevation angle of approximately 90°); behind and above the listener 2000 (e.g. at the virtual location 2033, with direction 2043 and at an elevation angle between 90° and 180°); behind the listener (e.g. at the virtual location 2034, with direction 2044 and at an elevation angle of approximately)+/−180°); behind and below the listener 2000 (e.g. at the virtual location 2035, with direction 2045 and at an elevation angle of between 180° and 270°, or between −90° and 180°); below the listener 2000 (e.g. at the virtual location 2036, with direction 2046 and at an elevation angle of approximately 270° or −90°); or in front of and below the listener 2000 (e.g. at the virtual location 2037, with direction 2047 and at an elevation angle between 270° and 0/360°, or between 0° and −90°). It is of course envisaged that the component may also be virtually localized at any other virtual location within the median plane 2010 (e.g. at an arbitrary elevation angle between 0 and 360°, somewhere on the circle 2050). The perceived distance between the listener and the virtual location of a particular component (e.g. the radius of the circle 2050) may also be altered, for example by changing the attenuation/amplification characteristics of the one or more filter applied to the component.

FIG. 2b illustrates schematically another perspective view of the head of a listener 2100, but wherein (in contrast to the example described with reference to FIG. 2a) the single speaker is not located within the median plane 2010 of the listener 2100. In the example shown in FIG. 2b, the location 2130 (as illustrated by the filled circle) of the single speaker is to the left side of the listener 2100, at a finite azimuth angle 2170, θ between 0 and 180°. Even though the location 2130 of the single speaker is no longer within the median plane 2110, which has a depth (e.g. a forward/backward direction 2120), the method according to the present disclosure still provides a way of virtually localizing a component at virtual locations (as illustrated by empty circles) other than the location 2130. For example, a filter may be applied to a component such that the component is virtually localized at the virtual location 2131, which has an elevation angle 2160, φ. Both the location 2130 and the virtual location 2131 lie in a half plane 2112 which has a same upward/downward direction 2122 as the median plane 2110 but which is oriented at the angle 2170 with respect to the median plane 2110. The half plane 2112 is bounded by the median plane 2110 along the axis of upward/downward direction 2122 but may extend infinitely in the direction 2124 and the upward/downward direction 2122. Depending on the filter applied to the component, the component may be virtually localized at any location on the half circle 2152, e.g. with an elevation angle 2160 between 0 and +/−90° (or between 0 and 90°, or between 270 and 360°). All virtual locations on the half circle 2152 may be defined as being “in front of” or “to the side of” the listener 2100 or there between.

A component may also be virtually localized at a virtual location lying on the half circle 2154, such as e.g. the virtual location 2132 having an elevation angle 2161, φ′. The virtual location 2132 and the half circle 2154 lie in a further half plane 2114 which also shares the direction/axis 2122 with the median plane 2110. The further half plane 2114 is bounded by the median plane 2110 along the axis of upward/downward direction 2122 but may extend infinitely in the direction 2126 and the upward/downward direction 2122. The half plane 2114 is arranged at an azimuth angle 2171, θ′ with respect to the median plane 2110, as illustrated in FIG. 2b. The angle 2171 may equal the angle 2170, such that an angle between the half planes 2112 and 2114 is (the absolute value of) 180° minus two times the angle 2170. All virtual locations on the half circle 2154 may be defined as being “to the side of” or “behind” the listener 2100 or there between.

The definitions of the half planes 2112 and 2114 and the half circles 2152 and 2154 are such that, if assuming that the head of the listener 2100 is spherically shaped, sounds played simultaneously from various sound sources located at different locations on e.g. one or both of the half circles 2152 and 2154 would have a same time of arrival with respect to the head (or e.g. an ear) of the listener 2100. Consequently, the method according to the present disclosure allows to virtually localize one or more sound sources as described herein also when the monaural playback device (e.g. a single speaker with one or more drivers) is not located for example directly in front of, and/or not within the median plane 2110 of, the listener 2100. If the azimuth angles 2170 and 2171 both approach zero degrees, it is envisaged that the two half-planes 2112 and 2114 together will span the equivalence of the median plane 2110, and that the two half circles 2152 and 2154 together will form a circle equivalent to the circle 2050 shown in FIG. 2a. The example described with reference to FIG. 2b will then be equal to the example described with reference to FIG. 2a. It is, of course, also envisaged that the single speaker and the location 2130 may instead be to the right of the user (e.g. such that the azimuth angles 2170 and 2171 are negative). The same capability of virtual localization of one or more sound components still applies in such a situation.

FIG. 2c illustrates schematically the example described above with reference to FIG. 2b, but from a top-down perspective.

The location 2130 (or 2030) may for example be the location of a single speaker of a mobile phone, a portable speaker device or similar. An audio signal may include multiple components, such as e.g. left and right stereo components, a plurality of surround sound components, a plurality of audio objects including a sound and accompanying location metadata, speech and non-speech components, or similar. Without the method of the present disclosure, the intended spatial separation of such components may be destroyed when downmixing the audio signal into a monaural signal before playback using a single speaker. This may lead to a cluttered sound stage, especially if all components are perceived as originating from a same location (the location of the single speaker). With the method of the present disclosure, however, the intended spatial separation may not always be preserved but at least transformed into an alternative spatial separation/differentiation (e.g. within the median plane of the listener). This is achieved by appropriate filtering of one or more of the components. By downmixing the audio signal such that this alternative spatial separation/differentiation is at least partly preserved, such cluttering of the sound stage may be avoided, and allow for an enhanced listening experience when using e.g. mobile phones, portable speakers or similar with only a single speaker available.

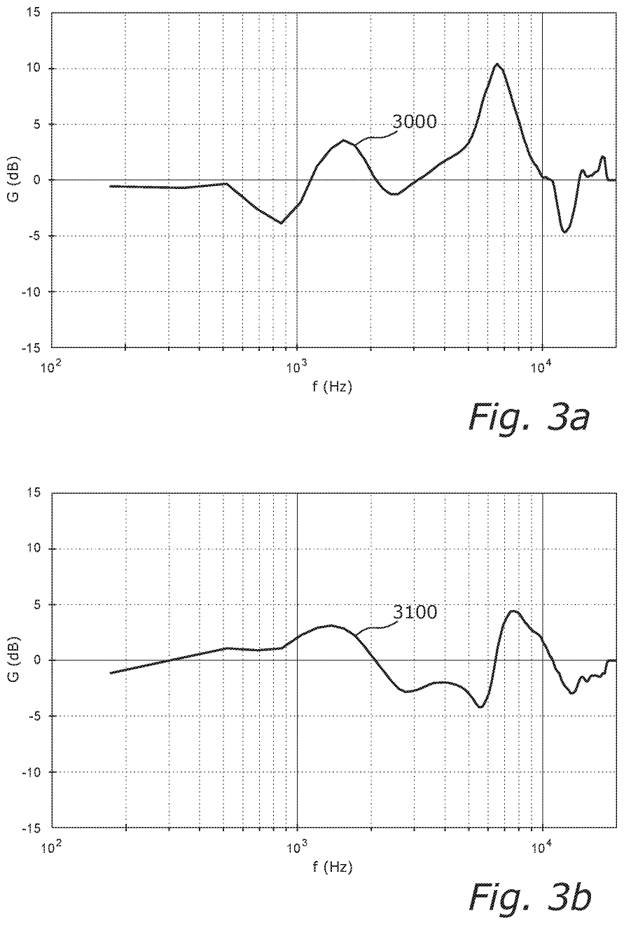

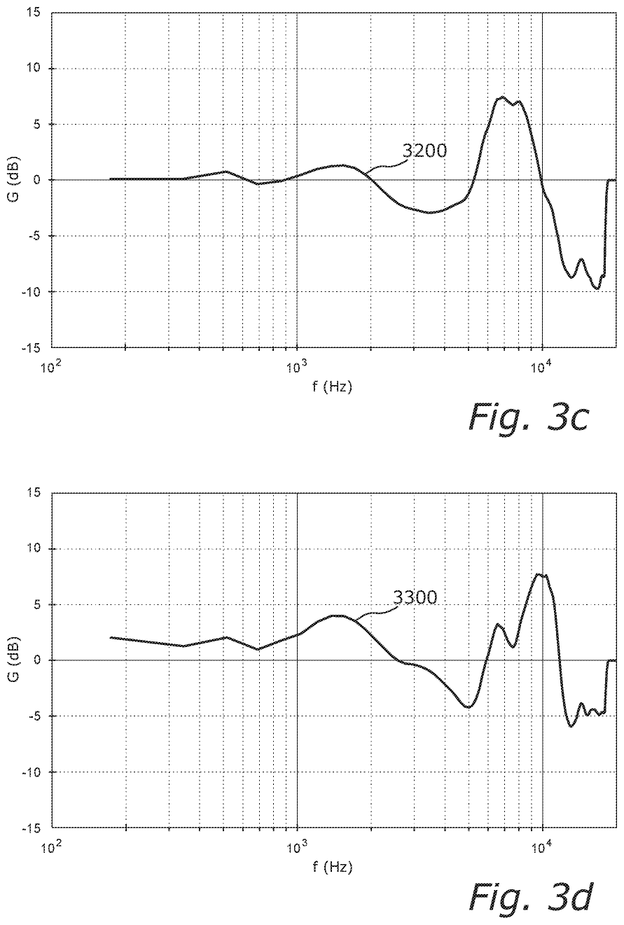

With reference to FIGS. 3a to 3d, examples of various filters usable in one or more embodiments of the method according to the present disclosure will now be described in more detail.

FIG. 3a illustrates a plot of an amplitude (G, in units of dB) of a frequency response (curve) 3000 of a first filter. The amplitude is plotted on a logarithmic scale as a function of frequency (f, in units of Hz). Such a first filter may allow to virtually localize a sound component at a finite, positive elevation angle and in front of a listener. For example, such a first filter may allow to virtually localize a component at the virtual location 2031 illustrated in FIG. 2a. Such a first filter may be referred to as a “virtual front height filter”.

FIG. 3b illustrates a plot, using similar axis as in FIG. 3a, of an amplitude of a frequency response 3100 of a second filter. Such a second filter may allow to virtually localize a sound component at a finite, negative elevation angle and in front of a listener. For example, such a second filter may allow to virtually localize a component at the virtual location 2037 illustrated in FIG. 2a. Such a second filter may be referred to as a “virtual front depth filter” (where depth, in this case, does not relate to a forward/backwards direction but to an upwards/downwards direction).

FIG. 3c illustrates a plot, using similar axis as in FIG. 3a, of an amplitude of a frequency response 3200 of a third filter. Such a third filter may allow to virtually localize a sound component at a finite, positive elevation angle and behind a listener. For example, such a third filter may allow to virtually localize a component at the virtual location 2033 illustrated in FIG. 2a. Such a third filter may be referred to as a “virtual rear height filter”.

FIG. 3d illustrates a plot, using similar axis as in FIG. 3a, of an amplitude of a frequency response 3300 of a fourth filter. Such a fourth filter may allow to virtually localize a sound component at a finite, negative elevation angle and behind a listener. For example, such a fourth filter may allow to virtually localize a component at the virtual location 2035 illustrated in FIG. 2a. Such a fourth filter may be referred to as a “virtual rear depth filter”.

Above, when referring to an elevation angle as being positive or negative, it should be noted that the elevation angle is defined similarly to the elevation angle 2060 illustrated in FIG. 2a. Phrased differently, a finite positive/negative elevation angle includes locations on e.g. the upper/lower half, respectively, of the circle 2050 illustrated in FIG. 2a.

It is noted that many additional variations of filters may be needed in order to virtually localize one or more components at arbitrary locations in the median plane of the listener (or at least with a finite elevation angle with respect to a horizontal plane of the listener). The present disclosure envisages that such filters may be obtained (using e.g. simulation, measurements on various head models for various locations of sound sources, or combinations thereof) for a set of virtual locations including various locations on e.g. the circle 2050 illustrated in FIG. 2a. To reduce the number of required locations in such a set, it is envisaged that e.g. interpolation may be used to virtually locate a component at a position between two locations in such a set. To take into account the possibility that the monaural playback device (e.g. the single speaker with one or more drivers) need not be positioned directly in front of, or not even within the median plane of, the listener, it is envisaged also that additional virtual locations may be added to the above set also for locations lying at e.g. a finite azimuthal angle with respect to the median plane of the listener (e.g. locations on e.g. one or both of the half circles 2152 and 2154 illustrated in FIG. 2b). Also here it is envisaged that interpolation may be used to reduce the required number of such additional virtual locations. In some embodiments, it may also be envisaged that an averaging procedure may be used, wherein e.g. simulations and/or measurements are performed for a plurality of different azimuthal angles (both zero and finite) for a certain elevation angle, and that an average filter is constructed for the certain elevation angle. For example, frequency response curves may be averaged over a plurality of finite azimuthal angles for a certain elevation angle, and the average filter thus obtained may work to approximately localize a component at an intended elevation even if the listener is not facing directly towards the monaural playback device. Such filters may also be useful if there are several listeners in a room, as it may not always be expected that each listener is always facing the monaural playback device.

In other embodiments, it is envisaged that the location and/or attitude (e.g. the orientation of the head) of the listener may be tracked continuously within e.g. a room, and that the various filters described herein may be dynamically adapted such that they take into account the current location and/or attitude of the listener. This may for example help to equalize timbral shifts when using a speaker having frequency dependent directionality. As an example, a smart speaker may measure where a listener is sitting (or is located) within a room. This may be achieved by e.g. playing a chirp pulse from a user's mobile phone and direction finding using multiple microphones on the smart speaker, the known position of the listener and measured responses may be used to equalize an effect of the room to ensure that the virtualization is still effective. Various other sensors, such as gyroscopes or similar, may also be used to detect not only the position but also the attitude of the (head of the) listener. As one alternative, the detected position and attitude may be used to advise the listener in which way to turn/pivot the head and/or the direction of the speaker to point in an optimal or at least more optimal direction. The measurement of listener position (and/or attitude) may be done once (before starting the listening), but also continuously while listening.

It is further noted that head-related transfer functions (HRTFs) may be used to obtain the spectral response curves required to virtually position a sound component at a specific location (e.g. at a specific location within a median plane of a listener). As e.g. the shape of the head, and/or of the pinna, may vary between different individuals, obtaining a single set of spectral response curves (e.g. a single set of filters) that works equally well for different individuals may be hard or impossible. It may therefore be useful to tune the HRTFs to the individual, and where needed to provide an individualized set of filters for a certain individual which is to use the monaural playback device in question. If not possible to provide such an individualized set of filters for each individual, averaging over the HRTFs of several individuals is envisaged as one solution in order to be able to at least approximately correctly localize components for several individuals using the same set of filters.

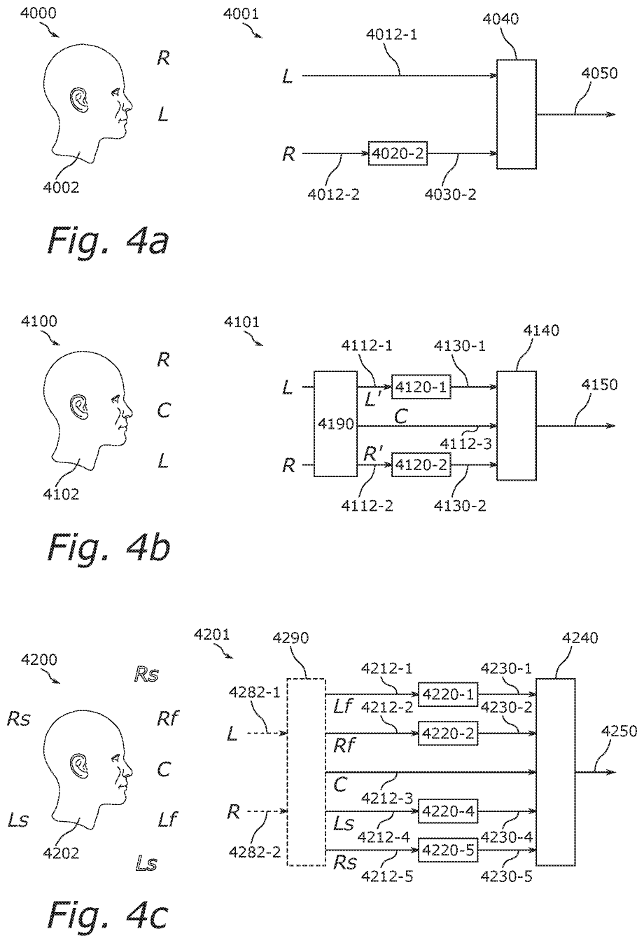

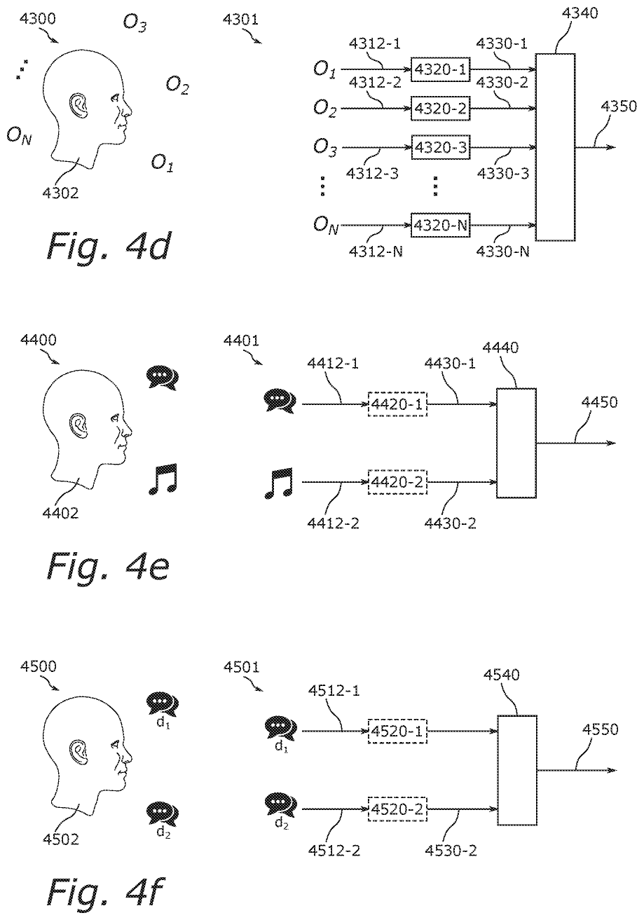

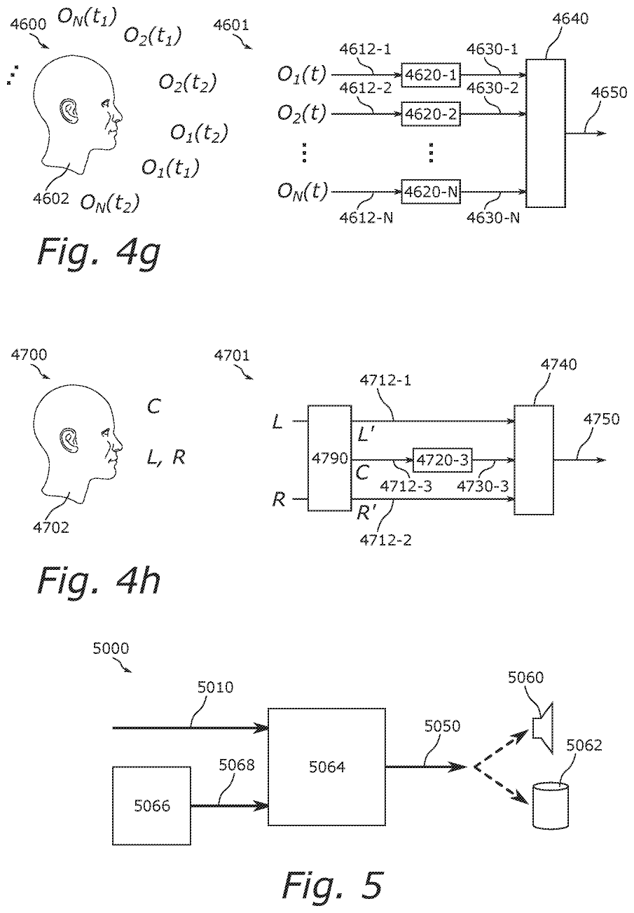

With reference to FIGS. 4a to 4h, various examples of flowcharts for various embodiments of the method according to the present disclosure, for creating a perceived differentiation in direction between components, will now be described in more detail.

FIG. 4a illustrates schematically one example of a sound stage (or perceived listening experience) 4000 for a listener 4002 using a monaural playback device, wherein a perceived elevation of a right component (R) is perceived as being higher than that of a left component (L). Such a perceived differentiation in direction may be achieved by a method 4001. The received audio signal includes a left component 4012-1 and a right component 4012-2. The processing of the audio signal includes applying at least one filter to at least one component. The left component 4012-1 is left unchanged, while a filtering stage includes a virtual (front) height filter 4020-2 which is applied to the right component 4012-2. The left component 4012-1 and the filtered right component 4030-2 are input into a mixing stage 4040, which downmixes both components into a monaural signal 4050. The presence of the monaural cues introduced into the right component by the virtual height filter 4020-2 is at least partly preserved by the downmixing in the mixing stage 4040, such that the monaural signal 4050, when played back to the user on a single speaker, gives the perceived listening experience 4000. Of course, a similar experience may also be provided by leaving the right component 4012-2 unaltered, and instead applying e.g. a virtual (front) depth filter (not shown) to the left component 4012-1. The resulting monaural signal would then still have a perceived differentiation in direction between the right and left component, wherein the elevation of the right component is still perceived as being higher than that of the left component.

Applying the filter 4020-2 to the right component may be advantageous as high-frequency sounds (such as hi-hats) in modern music are often panned to the right side after studio mixing, and because such high-frequency sounds may respond well to the use of such a virtual height filter. When producing e.g. a music record or similar, studio mixing may provide an intended differentiation in direction between the two components (such as a left/right differentiation). The method according to the present disclosure allows to maintain a differentiation but in a different plane, namely e.g. in the median plane of the listener instead of in a horizontal plane of the listener, also after downmixing into a monaural signal. Cluttering of the sound stage may thus be avoided.

Generally herein, “higher/lower is to be interpreted as being “physically higher/lower” (e.g. physically above/below) and not e.g. only having a larger/smaller elevation angle (an object with an elevation angle of e.g. above 90 and below 180 degrees may for example be “lower” than an object with an elevation angle of 90 degrees, and vice versa, even though the elevation angle of the former is less than that of the latter).

FIG. 4b illustrates another example, wherein the sound stage 4100 for the listener 4102 is such that also a center component 4112-3 (C) is included among the one or more components. For example, the method 4101 may extract the center component 4112-3 from a left component (L) and a right component (R) using a preprocessing stage 4190. In some embodiments, it is envisaged that the extraction of the center component 4112-3 may result in the originally received left and/or right components being different from the components 4112-1 and 4112-2 (such that L≠L′ and/or R≠R′). In other embodiments, it is envisaged that the extraction of the center component does not change the originally received components (such that L=L′ and R=R′). A filtering stage includes a depth filter 4120-1 which is applied to the left component 4112-1, and a height filter 4120-2 which is applied to the right component 4112-2. The extracted center component 4112-3 and the filtered left component 4130-1 and the filtered right component 4130-2 are input to a mixing stage 4140 which downmixes (while at least partly preserving the presence of the monaural cues introduced by the filters 4120-1 and 4120-2) the components into a monaural signal 4150. When played back to the listener 4102 using a monaural playback device (not shown), the monaural signal 4150 gives the listener 4102 the perceived differentiation between the components as illustrated by the sound stage 4100, e.g. such that the perceived differentiation in direction includes a perceived elevation of the center component being between the perceived elevations of the left component and the right component. The example described with reference to FIG. 4a may provide a brighter soundscape than the original audio signal. At a small increase in computational cost, the example described with reference to FIG. 4b may provide a cleaner sound for center panned speech and vocal, a balanced timbre and a larger separation for sounds that were well separated in the original mix.

FIG. 4c illustrates another example, wherein more sound components are involved. In the method 4201, the received audio signal (the left component 4282-1 and the right component 4282-1) is upmixed by a preprocessing stage 4290 into a left front component 4212-1, a right front component 4212-2, a center component 4212-3, a left surround component 4212-4 and a right surround component 4212-5. Such a configuration may be useful e.g. for a received audio signal provided in Dolby Pro Logic II format. In other embodiments, it is envisaged that the various surround components are provided directly (e.g. the various surround components are included in the received audio signal), in e.g. a Dolby Surround 5.0 format, and that parts or the whole of the preprocessing stage 4290 is therefore not needed. The center component may be optional, which also applies to some but not all of the other components. A filtering stage includes a virtual front depth filter 4220-1 which is applied to the left front component 4212-1, a virtual front height filter 4220-2 which is applied to the right front component 4212-2, a virtual rear depth filter 4220-4 which is applied to the left surround component 4212-4 and a virtual rear height filter 4220-5 which is applied to the right surround component 4212-5. The center component 4212-3 and the filtered components 4230-1, 4230-2, 4230-4 and 4230-5 are input to a mixing stage 4240 and downmixing into a monaural signal 4250 (with the presence of at least part of the monaural cues introduced by the various filters being preserved). If played back to a listener 4202, the monaural signal 4250 gives a perceived soundstage 4200, wherein a perceived elevation of the left front component is lower than a perceived elevation of the right front component, and wherein a perceived elevation of the left surround component is lower than a perceived elevation of the right surround component. A perceived location of the left surround component and the right surround component is behind the listener 4202. In other embodiments, it may also be envisaged that the various surround components are, instead or in addition, given a perceived wider elevation than their corresponding front components. For example, filters 4220-4 and 4220-5 applied to the left/right surround components 4212-4/4212-5, respectively, may instead, or in addition, be such that the surround components are virtually localized below/above the corresponding left/right front components 4212-1/4212-2. The surround components are then not necessarily located behind the listener 4202. This is illustrated in the soundstage 4200 in FIG. 4c with unfilled letters Rs and Ls. It may also be envisaged that the perceived locations of the surround components are, instead or in addition, further away from the listener than the perceived locations of the front components.

In general, it is envisaged that the one or more components in the received audio signal may include at least a left component and a right component, and that at least one or more of a center component, a left front component, a right front component, a left surround component and a right surround component are not already present among the one or more components when receiving the audio signal but added to the one or more components by upmixing of the left component and the right component.

The above example may be seen as virtually “tipping” the original soundstage on its side. An original differentiation in a horizontal plane of the listener 4202 is instead provided in e.g. a median plane of the listener 4202, such that differentiation between various components is still available after downmixing into the monaural signal 4250. It is of course envisaged also that more components (e.g. more surround channels) may be added by the upmixing, or provided directly in the received audio signal, to create a more complex sound stage and to more accurately place sounds around e.g. the median plane of the listener 4202.

The above example may also be relevant for e.g. audio provided in Dolby Digital 5.1 format. It may then be envisaged that the low frequency effects (LFE) channel/component is either mixed into the center component with some optional gain, or that the LFE channel/component is dropped. Also here may upmixing be used to provide even further components which may be virtually localized at different locations within e.g. the median plane of the listener 4202.

FIG. 4d illustrates an example wherein the components of the received audio signal (or as extracted from the received audio signal) include one or more audio objects, using for example a Dolby Atmos format. Here, an “audio object” is to be understood as an object represented by an audio content and accompanying positional metadata telling where within a room the audio object is to be localized. The positional data for each object may for example be provided as an (x,y,z)-coordinate, each coordinate element ranging from e.g. −1 to 1. The coordinate element “x” may e.g. indicate an intended left/right coordinate, the coordinate element “y” may e.g. indicate an intended front/back coordinate, and the coordinate element “z” may e.g. indicate an intended up/down coordinate. In one embodiment, the intended location/position of such an audio object may be mapped to a corresponding location within e.g. a median plane of a listener 4302. The mapping may be realized by applying one or more appropriate filters to the component in question. For example, the original (x,y,z)-coordinate for the audio object may be mapped into an (x′,y′,z′)-coordinate. The front/back coordinate may remain the same, such that y′=y. The x and z coordinates (e.g. the left/right and up/down coordinates) may be combined with two goals in mind, namely i) to map sounds that are originally far from the center front such that they are far from the center front also after the mapping, and thereby keeping center panned dialogue as clear as possible, and ii) to map sound having height such that they have height also after the mapping, if possible. One useful such mapping may be provided as max(abs(x), z)->z′, although it is envisaged also that many other alternative mappings may also be relevant.

In the exemplary method 4301, N audio objects O₁ to O_{N} (where N is an integer such that N≥1) are included in the received audio signal as components 4312-1 to 4312-N. After mapping the original locations of the audio objects into positions/coordinates in e.g. the median plane of the listener 4302, a filtering stage includes one or more filters 4320-1 to 4320-N which are applied to the components 4312-1 to 4312-N to create filtered components 4330-1 to 4330-N. As before, if a filter is not applied to a specific component, the “filtered” version of that specific component may equal the corresponding unfiltered component. The filtered components 4330-1 to 4330-N are then input to the mixing stage 4340, which while preserving at least partly the monaural cues introduced by the filters downmixes the components into a monaural signal 4350. When played back to the listener 4302 using a monaural playback device, the mapped-to locations within e.g. the median plane are experienced by the listener 4302 as a perceived differentiation in direction between the various components (as indicated by the soundstage 4300 in FIG. 4d).

More generally, the one or more components in the received audio signal may include a first component representing a first audio object associated with a first location in space. At least one filter may be applied to the first component, and the perceived differentiation in direction as described herein may include a perceived position of the first component being based on the first location in space. In some embodiments, the one or more components may include a second component representing a second audio object associated with a second location in space different from the first location. The perceived differentiation in direction may then include a perceived position of the second component based on the second location in space and different from the perceived position of the first component.

In other examples, audio objects may be rendered to e.g. 5.1 or 7.1 audio format (not shown in the Figures), and then mapped to the medial plane just as in e.g. the method 4201 shown in FIG. 4c. This may imply collapsing any height (up/down) coordinate, and then “tipping” the sound stage on its side with the right side pointing up. It is of course also envisaged that the soundstage may be “tipped” in the other direction, such that the left side is pointing up instead.

FIG. 4e illustrates an example wherein differentiation is created between speech and non-speech components. In the method 4401, one component 4412-1 is more likely to contain speech, and another component 4412-2 is more likely to contain non-speech (such as music, or other sounds). A filtering stage includes a filter 4420-1 (such as a virtual height filter) which may be applied to the speech component 4412-1, and/or a filter 4420-2 (such as a virtual depth filter) which may be applied to the non-speech component 4412-2. The filtered components 4430-1 and/or 4430-2 are downmixed in a mixing stage 4440 to a monaural signal, while preserving at least partly the various monaural cues introduced by the filters. When played back to a listener 4402 using a monaural playback device, the soundstage 4400 perceived by the listener 4402 is such that the speech component is elevated with respect to the non-speech component. Phrased differently, the perceived differentiation in direction may include a perceived elevation of a particular component which contains, or is more likely to contain, speech may be higher than a perceived elevation of one or more other components.

Differentiation in direction of the components with respect to speech/non-speech content may help to enhance dialogue and to prevent dialogue/speech otherwise being buried within various non-speech components (such as background music or similar). It may be envisaged also that the speech and non-speech components are not provided as separate components directly in the received audio signal. Then, other means (such as signal/statistical analysis and/or various filtering, not shown) may be used to separate speech from non-speech and to thereby create the two components 4412-1 and 4412-2. It is of course also envisaged that there may be more than one such speech-component, and more than one non-speech component.

FIG. 4f illustrates an example wherein differentiation in direction is created between speech components having different properties. Such properties may for example be voice pitch, the user to which a certain voice belongs, or similar. An audio signal provided as part of e.g. a teleconference may be analyzed and the voices from each participant may be extracted as separate speech components. In other embodiments, the voice audio of each participant may be directly provided as a separate speech component. In the method 4501, a filtering stage includes a virtual height filter 4520-1 which may be applied to one such speech component 4512-1 (d₁), and/or a virtual depth filter 4520-2 which may be applied to another such speech component 4512-2 (d₂). The speech component 4512-1 may for example be the voice having the highest pitch, and the speech component 4512-2 may for example be the voice having the lowest pitch. The filtered components 4530-1 and/or 4530-2 are then input to a mixing stage 4540 which, while preserving at least partly the various monaural cues introduced by the filters, downmixes the components into a monaural signal 4550. When played back to a listener 4502 using a monaural playback device, a perceived soundstage 4500 may be created for the listener 4502 such that different voices appear to be located at different positions within e.g. a median plane of the listener 4502. This may provide, e.g. during a teleconference, a separation of voices/participants and provide an enhancement of intelligibility. Other criteria for how to separate the various components are of course also envisaged. More generally, the one or more components may include a first speech component having a higher pitch and a second component having a lower pitch. At least one filter may be applied to at least one of the first speech component and the second speech component, and the perceived differentiation in direction may include a perceived elevation of the first speech component being higher than a perceived elevation of the second speech component.

It is further envisaged that, in some embodiments, the at least one filter applied to one or more of the various components may adapt to a listener position in a room with respect to the monaural playback device, a listener orientation in the room with respect to the monaural playback device, and/or to acoustics of the room.

Although always illustrated herein as including at least two components, the received audio signal may also be envisaged as being derived from a mono source. For example, a mono signal may be upmixed to stereo using for example a filter bank with delays sufficient to decorrelate the corresponding frequencies, and then render the stereo as described with reference to e.g. any one of FIGS. 4a, 4b, 4c and 4h in order to provide a wider soundstage. Such embodiments of the method according to the present disclosure may be useful e.g. for podcasts and radio where a received signal may be predominantly or entirely mono.

FIG. 4g illustrates an example wherein the received audio signal includes one or more audio objects depending on time. In the method 4601, a plurality of audio objects O₁(t) to O_{N}(t), where N is an integer such that N≥1 are include in the received audio signal, as respective components 4612-1 to 4612-N. A filtering stage includes corresponding filters 4620-1 to 4620-N which are applied to the components 4612-1 to 4612-N to create filtered components 4630-1 to 4630-N. Once again, a filter is not necessarily applied to each of the components 4612-1 to 4612-N, and if a particular component is unfiltered, the “filtered” version of that component may equal the unfiltered version. However, in this example, the filters take into account the time variance of the audio objects, such that one or more of the filters 4620-1 to 4620-N are also time-varying. After downmixing the filtered components 4630-1 to 4630-N into a monaural signal 4650 using a downmixing stage 4640 (while preserving at least partly the various monaural, now time-varying, cues introduced by the one or more filters), the monaural signal 4650 may be played back to a listener 4602 using a monaural playback device (not shown), such that the listener 4602 experiences the soundstage 4600. The soundstage 4600 will be time-varying, and the perceived location of (and perceived differentiation in direction between) the various components will therefore change with time. As illustrated in the soundstage 4600, the first audio object O₁ will be at a different perceived location at time t₂ than what it was at an earlier time ti. The same applies also to the other components O₂ to O_{N}.

Phrased differently, the received audio signal may include one or more components, and a first component of these components may represent a first audio object associated with a first location in space varying over time. The filtering may be such that the one or more monaural cues introduced by one or more filters applied to the first component also vary with time, and such that, when the monaural signal is played back to the listener 4602, the listener 4602 experiences a perceived differentiation in position of the one or more components, including a perceived position of the first component varying over time based on the first location in space. In some embodiments, the one or more components in the received audio signal may include also a second component representing a second audio object associated with a second location in space varying over time. At least one filter may be applied also to the second component, and the thereby introduced monaural cues may be time varying and such that, when played back to the listener 4602, the perceived differentiation in position includes also a perceived position of the second component varying over time based on the second location in space, where the perceived position of the second component may be different from the perceived position of the first component when the first location in space is different from the second location in space.

FIG. 4h illustrates an additional example of how the spatial separation of components may provide an increased speech intelligibility. Traditionally, when presenting audio over a mono speaker, and dialogue/speech is collapsed into e.g. the other content (such as music and/or effects) of the audio. However, for signals where dialogue/speech is reasonably separated, such as for e.g. channel-based immersive (CBI) or object-based immersive (OBI) formats, the method of the present disclosure allows the dialogue/speech to be separated perceptually using only a single speaker. As illustrated in FIG. 4h, one such exemplary method 4701 includes extracting a center channel/component 4712-3 from a left component (L) and a right component (R) using a preprocessing stage 4790. In some embodiments, it is envisaged that the extraction of the center component 4712-3 may result in the originally received left and/or right components being different from the components 4712-1 and 4712-2 (such that L≠L′ and/or R≠R′). In other embodiments, it is envisaged that the extraction of the center component does not change the originally received components (such that L=L′ and R=R′). To improve dialogue clarity, a filtering stage includes a filter 4720-3 (such as a virtual height filter) which is applied to the center component 4712-3, while the left component 4712-1 and the right component 4712-2 are input directly to a mixing stage 4740 together with the filtered center component 4730-3. As usual, after downmixing in the mixing stage 4740 into a monaural signal 4750 (while at least partly preserving the presence of the various monaural cues introduced by the filtering), the monaural signal 4750 may be played back to a listener 4702 using a monaural playback device (not shown), resulting in a perceived sound stage 4700 wherein the center channel/component (where speech is often present) is separated from the left/right components.

In other embodiments, it is envisaged that various filters may be applied also to one or more of the other components, and also that there may be more other components than a left/right component. For example, one embodiment may include there being provided (either directly in the received audio signal, or by upmixing in a preprocessing stage as described earlier herein) a center component, a left front component, a right front component, a left surround component and a right surround component. Various filters (including e.g. virtual front height/depth filters) may be applied to the various components such that e.g. the center component is virtually located at a first elevation angle in e.g. a median plane of the listener 4702, such that the left and right front components are virtually located at a second elevation angle in the median plane, and such that the left and right surround components are virtually located at a third elevation angle in the median plane. The first, second and third angles may then be adjusted such that e.g. dialogue/speech intelligibility is optimized or at least improved.

Using the method according to the present disclosure to optimize/improve speech intelligibility may be useful for e.g. hearing-impaired people, who may otherwise have problems sorting out dialogue/speech from other components if all components are downmixed into a monaural signal and played back such that they all appear to originate from a same location.

For channel-based immersive (CBI) content, a typical approach has been to downmix to mono before playback using a monaural playback device. In case of e.g. a 5.1.2 channel based immersive mix, the method according to the present disclosure allows the placement of the speakers to be virtualized. By virtually localizing each component at different locations within e.g. a median plane of a listener, the perception of a higher channel count on a single speaker device may be achieved. As described earlier, such a virtual localization may correspond to that described with reference to e.g. FIG. 4c. Other configurations are also possible. For example, it is envisaged that a center component may be left unaltered, that left and right front components may be positioned in front of and above the user, that left and right (top) middle components may be positioned e.g. above the listener, and that left and right surround components may be positioned e.g. behind and above the listener (see e.g. FIG. 2a for definitions of the various locations). Further benefits of such a virtual localization over mono rendering may include a reduction in loudness buildup that may be caused by correlated signals which are typical of audio signals which have been rendered using e.g. an Object Audio Renderer. For example, multichannel audio which have been created through decorrelation to make sound more diffusive may often sound “phasey” when downmixed to mono. Such an artifact may be reduced using the single speaker virtualization of the method according to the present disclosure.

Although not illustrated explicitly herein, it is envisaged that virtualization as described herein may be obtained by instead, or in addition, changing not the perceived angle towards a component but the distance to the component. This may be obtained by, for example, the respective filters either attenuating or amplifying the component in a non-frequency depending manner. Attenuating a component may for example make the component appear more distant, while amplifying the component may make the component appear closer. It is envisaged that for example two components may be differentiated in distance only, such that they have e.g. a same direction but different perceived distances to the listener.

In some embodiments, it may for example be envisaged that the received audio signal is of an Ambisonics format, and that the one or more components for example are B-format components W, X, Y and Z (e.g. \vec{I}=(W; X; Y; Z)). Phrased differently, the one or more components may include a speaker-independent representation of a sound field. The preprocessing may include creating one or more speaker feeds from e.g. linear (or non-linear) combinations of W, X, Y, and Z, represented by \vec{I}_{SF}=ÛÎ. Filtering, or equivalent processing, may then be applied to one or more of the speaker feeds to introduce the one or more monaural cues to virtually locate each speaker feed at a different elevation, represented by \vec{I}_{SFV}=\hat{F}Î_{SF}. After downmixing, the signal O=\hat{D}Î_{SFV} would include the one or more monaural cues that would make a listener perceive each speaker feed as originating from a different location (or elevation). In such an embodiment, the resulting differentiation is not between the components (e.g. the B-format components) themselves, but rather between the speaker feeds and audio sources represented by/in the B-format components. It may also be envisaged that the preprocessing is included in the filtering, by adapting the filter such that the output monaural signal O=(\hat{D}\hat{F}′)\vec{I} equals or at least approximately equals O=(\hat{D}\hat{F}Û)\vec{I}. If e.g. \hat{F} and Û do not change with time, such an embodiment would beneficial e.g. in that the number of repeated matrix operations needed would be reduced.

With reference to FIG. 5, an embodiment of an audio preparation system according to the present disclosure will now be described in more detail.

FIG. 5 illustrates schematically an audio preparation system 5000. The system 5000 includes a computer processor 5064 and a non-transitory computer readable medium 5066. The medium 5066 may store instructions which are operable, when executed by the processor 5064, to cause the processor 5064 to perform the method according to the present disclosure, e.g. according to any of the embodiments of the method described herein, e.g. with reference to FIGS. 1a, 1b, and 4a to 4h. The medium 5066 is connected to the processor 5064 such that the medium 5066 may provide the instructions 5068 to the processor 5064. The processor 5064 may receive an audio signal 5010, prepare the audio signal according to the method, and output a monaural signal 5050, all as described earlier herein. The monaural signal 5050 may then be provided directly to a monaural playback device 5060, and/or to a storage device 5062 for later playback.

As also described earlier herein, the present disclosure also provides a non-transitory computer readable medium, such as the medium 5066 described with reference to FIG. 5, with instructions stored thereon which are operable, when executed by a computer processor (such as the processor 5064 described with reference to FIG. 5), to perform the method of the present disclosure (such as illustrated e.g. in the embodiments described with reference to FIGS. 1a, 1b, and 4a to 4h).

The present disclosure envisages a method, embodiments of which including receiving, by an audio processing/preparation system, an audio signal including a plurality of components; imparting, by the audio processing system to the components, a perceived differentiation in space, including a direction other than that of a monaural playback device, the imparting including applying at least one filter to at least one of the components. Such a method may also include mixing, by the audio processing system, the multiple components including the filtered at least one component into a monaural signal that maintains the differentiation of these components in space, and providing this monaural signal to the monaural playback device or a storage device. In some embodiments, the plurality of components may include a left component and a right component; the imparting includes applying a height filter to the right component, the height filter having a frequency curve that positions a sound source vertically; and the monaural signal differentiates the left component and the right component vertically in a medial/median plane, the medial/median plane being a virtual plane in a middle between the left and right and having height, depth and no width. In some embodiments, the method may include upmixing, by the audio processing system, the left component and the right component, the upmixing creating a center component and modified left and right components of the audio signal; and applying, by the audio processing system, a depth filter to the modified left, wherein the audio processing system applies the height filter to the modified right component, and the mixing includes mixing the filtered component, the filtered right component, and the center component into the monaural signal. In some embodiments, the audio signal received by the audio processing system may include a left front component, a right front component, a left surround component, and a right surround component, and the filters and the mixing may include vertically positioning the left front component to below the right front component in the monaural signal, virtually positioning the left surround component to below and/or behind the left front component in the monaural signal, and virtually positioning the right surround component to above and/or behind the right front component in the monaural signal. In some embodiments, the method may include increasing the number of components in the audio signal by upmixing at least one component of the audio signal, wherein each component may receive a respective filtering prior to the mixing. In some embodiments, the components may represent audio channels. In some embodiments, the components may include on or more audio objects associated with respective location data. In some embodiments, the audio processing system may determine differentiating filters to apply to the components based on the location data. In some embodiments, the method may include mapping the components to be represented by the monaural signal on a medial/median plane based on the location data, wherein an object location that is differentiated from the front center direction maps to a perceived direction that is differentiated from the front center perceived direction in the monaural signal and lies on the medial/median plane. In some embodiments, the audio signal may include components that represent speech. In some embodiments, a speech component having a higher pitch may map to a higher perceived location in the monaural signal. In some embodiments, a component that is more likely to contain speech than another component may map to a higher perceived location than the other component. In some embodiments, the at least one filter may include a filter that adapts to a listener position in a room. In some embodiments, the received audio signal may be derived from a mono source.

Embodiments of the subject matter and the functional operations described in this disclosure/specification may be implemented in digital electronic circuitry, in tangibly-embodied computer software or firmware, in computer hardware, including the structures disclosed in this disclosure/specification and their structural equivalents, or in combinations of one or more of them. Embodiments of the subject matter described in this disclosure/specification may be implemented as one or more computer programs, e.g., one or more modules of computer program instructions encoded on a tangible non-transitory program carrier for execution by, or to control the operation of, data processing apparatus. Alternatively, or in addition, the program instructions may be encoded on an artificially-generated propagated signal, e.g., a machine-generated electrical, optical, or electromagnetic signal, that is generated to encode information for transmission to suitable receiver apparatus for execution by a data processing apparatus. The computer storage medium may be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus may also be or further include special purpose logic circuitry, e.g., an FPGA (field programmable gate array) or an ASIC (application-specific integrated circuit). The apparatus may optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, may be written in any form of programming language, including compiled or interpreted languages, or declarative or procedural languages, and it may be deployed in any form, including as a stand-alone program or as a module, component, subroutine, or other unit suitable for use in a computing environment. A computer program may, but need not, correspond to a file in a file system. A program may be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program may be deployed to be executed on one computer or on multiple computers that are located at one site or distributed across multiple sites and interconnected by a communication network.

The processes and logic flows described in this disclosure/specification may be performed by one or more programmable computers executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application-specific integrated circuit).

Computers suitable for the execution of a computer program include, by way of example, may be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Embodiments of the subject matter described in this specification may be implemented in a computing system that includes a back-end component, e.g., as a data server, or that includes a middleware component, e.g., an application server, or that includes a front-end component, e.g., a client computer having a graphical user interface or a Web browser through which a user may interact with an implementation of the subject matter described in this specification, or any combination of one or more such back-end, middleware, or front-end components. The components of the system may be interconnected by any form or medium of digital data communication, e.g., a communications network. Examples of communications networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems may generally be integrated together in a single software product or packaged into multiple software products.

Thus, particular embodiments of the subject matter have been described. Other embodiments are within the scope of the following claims. For example, the subject matter is described in context of scientific papers. The subject matter may apply to other indexed work that adds depth aspect to a search. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous. While specific embodiments of the present invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

1. A method of preparing an audio signal for playback on a monaural playback device, comprising:
receiving an audio signal including one or more components, the one or more components including sound from one or more audio sources;
processing the audio signal to create a monaural signal, said processing including introducing one or more monaural cues into at least one component, and/or into at least one combination of components, of the one or more components, the monaural signal maintaining a presence of the one or more monaural cues; and
providing the monaural signal to the monaural playback device or to a storage device,
the one or more monaural cues being such that, if the monaural signal is played back to a listener using the monaural playback device, the listener experiences a perceived differentiation in direction of the one or more components and/or the one or more audio sources.

2. The method of claim 1, said processing including applying at least one filter to the at least one component and/or to the at least one combination of components.

3. The method of claim 1, wherein:
the one or more components include a left component and a right component; and
said processing includes processing the right component, and
wherein the perceived differentiation in direction includes a perceived elevation of the right component being higher than a perceived elevation of the left component.

4. The method of claim 3, wherein:
the one or more components include a center component; and
said processing includes processing the left component, and
wherein the perceived differentiation in direction includes a perceived elevation of the center component being between the perceived elevations of the left component and the right component.

5. The method of claim 1, wherein:
the one or more components include a left front component, a right front component, a left surround component, and a right surround component, and
wherein the perceived differentiation in direction includes:
a perceived elevation of the left front component being lower than a perceived elevation of the right front component;
a perceived elevation of the left surround component being lower than a perceived elevation of the right surround component; and
at least one of:
perceived locations of the left surround component and the right surround component being wider in elevation and/or further away from the listener than perceived locations of the left front component and the right front component and/or behind the listener; or
the perceived elevation of the left surround component being lower than the perceived elevation of the left front component, and the perceived elevation of the right surround component being higher than the perceived elevation of the right front component.

6. The method of claim 5, wherein:
the one or more components include a left component and a right component; and
at least one or more of the left front component, the right front component, the left surround component, and the right surround component is absent among the one or more components when receiving the audio signal but being added to the one or more components by upmixing of the left component and the right component.

7. The method of claim 1, wherein:
the one or more components include a first component representing a first audio object associated with a first location in space; and
said processing includes processing the first component,
wherein the perceived differentiation in direction includes a perceived position of the first audio object being based on the first location in space.

8. The method of claim 7, wherein:
the one or more components include a second component representing a second audio object associated with a second location in space different from the first location, and
wherein the perceived differentiation in direction includes a perceived position of the second audio object based on the second location in space and different from the perceived position of the first component.

9. The method of claim 7, wherein:
the first location in space varies over time;
the one or more monaural cues also vary over time and are such that the perceived differentiation in direction is a perceived differentiation in direction over time, including a perceived position of the first audio object varying over time based on the first location in space.

10. The method of claim 1, wherein
at least one particular component of the one or more components contains, or is more likely to contain, speech, and one or more other components of the one or more components do not contain, or are less likely to contain, speech; and
said processing includes processing the at least one particular component and/or processing the one or more other components, and
wherein the perceived differentiation in direction includes a perceived elevation of the at least one particular component being higher than a perceived elevation of the one or more other components.

11. The method of claim 1 wherein:
the one or more components include a first speech component having a higher pitch, and a second speech component having a lower pitch;
said processing includes processing the first speech component and/or processing the second speech component, and
wherein the perceived differentiation in direction includes a perceived elevation of the first speech component being higher than a perceived elevation of the second speech component.

12. The method of claim 1, wherein:
said processing includes processing adapting to a listener position in a room with respect to the monaural playback device, a listener orientation in the room with respect to the monaural playback device, and/or to acoustics of the room.

13. The method of claim 1, wherein:
the one or more components includes a speaker-independent representation of a sound field, the sound field including contributions from the one or more audio sources; and
wherein the perceived differentiation in direction includes a perceived differentiation in position for the one or more audio sources.

14. The method of claim 4, wherein the center component is not already being present among the one or more components when receiving the audio signal but is added to the one or more components by upmixing of the left component and the right component.

15. An audio preparation system, comprising:
a computer processor; and
a non-transitory computer readable medium storing instructions operable, when executed by the processor, to cause the processor to perform the method of claim 1.

16. A non-transitory computer readable medium storing instructions operable, when executed by a computer processor, to perform the method of claim 1.
